(19) United States
(12) Patent Application Publication
(10) Pub. No.: US 2004/0019695 A1
(43) Pub. Date: Jan. 29, 2004

(54) Messaging system and method using alternative message delivery paths

(75) Inventors: Craig William Fellenstein, Brookfield, CT (US); Carl Phillip Gusler, Austin, TX (US); Rick Allen Hamilton II, Charlottesville, VA (US); Harry Schatz, McLean, VA (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/205,571

(22) Filed: Jul. 25, 2002

(51) Int. Cl. G06F 15/173; G06F 15/16

(52) U.S. Cl. 709/239; 709/229

(57) ABSTRACT

A system, method, and computer program product enable instant messaging systems to use alternative message delivery mechanisms. Recipients may register one or more alternative message delivery mechanisms, such as cell phones, pagers, etc., through which they are available as an alternative to an instant messaging system. Constraints may be added to these registered alternatives, such as specifying a limitation on days of the week and/or hours of the day when a particular alternative may be used. Providing that an alternative messaging mechanism is registered, and any constraints for this alternative are satisfied, the present extended instant messaging system selects the most suitable alternative forwarding mechanisms, and delivers the messages to the intended recipients.

### CROSS-REFERENCE TO RELATED APPLICATION

The present application is related to co-pending U.S. patent applications Ser. No. 09/365,915, filed Aug. 3, 1999, and titled “Technique for Enabling Messaging Systems to Use Alternative Message Delivery Mechanisms,” and Ser. No. 10/085,900, filed Feb. 28, 2002, and titled “Technique for Enabling Wireless Messaging Systems to Use Alternative Message Delivery Mechanisms,” both of which are assigned to the same assignee as the present application.

### FIELD OF THE INVENTION

The present invention relates to a computer system, and more particularly with a method, system, and computer program product for enabling messaging systems to use alternative message delivery paths. The present invention extends the real-time awareness aspect of instant messaging. As an example, using the present invention, messages may still be delivered in the event an intended receiver is logged on to an instant messaging system, but is away from his or her computer. Alternatively, the present invention enable messages to be delivered from a sender using a wireless messaging service via a mechanism for which a recipient has registered his or her availability.

### BACKGROUND OF THE INVENTION

Instant messaging systems provide real-time communication between users who are connected to the systems through an on-line or electronic networking environment. Instant messaging systems are quite popular among Internet, Intranets, and Extranet users because they are user friendly and provide a simple, inexpensive way to send instantaneous messages.

One of the instant messaging systems' powerful tools is the ability to provide real-time awareness of who is logged on to the network. Typically, an instant messaging system user has an address book containing names or nicknames for individuals with whom he/she communicates. The address book entries are used for selecting one or more message recipients. The instant messaging system indicates to the user those addressees who are logged on to the system. This is accomplished via visual cues such as different icons or different fonts. For a message to be sent instantaneously, the messaging systems require that both sender and recipient be simultaneously logged on to an instant messaging system, which may be the same instant messaging system, or a different instant messaging system. By ensuring that the receiver is available when a message is sent to him/her, the message can be delivered and presented to the recipient nearly instantly (depending on network delay).

Wireless messaging systems such as two-way paging systems and text messaging services using digital cellular telephone networks, have some of the same characteristics of instant messaging systems. But they have a number of drawbacks regarding message delivery most important of which is the lack of interface with the instant messaging systems. In turn, this may cause delays in relaying messages, thus losing the real-time awareness attribute that is a key benefit of an instant messaging system.

Therefore, there still remains a need for improving the conventional design applications of instant messaging systems. As an example, in the event that an instant message reaches the terminal of a user who is logged on to the system, but who is actually away from the computer, the message may go unheeded for a length of time, which defeats the purpose of instant messaging.

### SUMMARY OF THE INVENTION

The present invention satisfies this need, and provides a messaging system and associated method that extend instant messaging systems to enable users to use alternative message delivery mechanisms or paths to deliver instant messages. As an example, the present instant message system of the present invention is capable of delivering instant messages to a recipient who is still logged on to an instant messaging system, but is either distracted or physically remote from the computer, based on a set of user-configurable forwarding rules that determine if, and how the recipient is reachable.

It is not uncommon for an individual to log on to an instant messaging system and then leave the computer unattended for some time during the course of the day, without logging out of the instant messaging system. The present invention addresses such and similar scenarios, and provides one or more alternative ways to contact the recipient via the instant messaging system, or in other terms, to keep the individual (or user) virtually connected to the computer.

The present invention extends the message delivery capabilities of instant messaging systems by enabling messages to be sent from the instant messaging systems to logged-on users who are reachable through alternative delivery paths. This technique is user-configurable, that is it follows a set of forwarding rules according to receiver-defined preferences, such as hierarchy of forwarding coordinates, mechanism of forwarding coordinates, or other similar forwarding constraints. These alternative delivery mechanisms are defined by the recipient in an electronic registry.

The foregoing and other features and objects of the present invention are provided by a system and associated method that ensure the receipt of an “instant message” that has not been acknowledged by the recipient. The system transmits the instant message to one or more of the recipient's approved alternative communication devices, such as cellular phone, pager, Personal Digital Assistant (PDA), or any other wireless or communication device. Alternatively, the system could ensure that the unacknowledged instant message be transmitted to the recipient's voicemail or email.

To this end, the recipient's instant messaging system is provided with a set of rules (referred to herein as forwarding rules) to determine when an instant message is unacknowledged, and if and by which alternative medium (or pathway) the message is to be forwarded. Once the unacknowledged instant message is authorized for transfer has satisfied the forwarding rules, the system transmits (or transfers) the message to a recipient's designated alternative communication device via the alternative pathway, thus virtually extending the otherwise limited coverage of the instant messaging system, rendering it more user friendly and amenable for everyday practical user.

To enable such transfer of the instant messaging session to the recipient's alternative communication device, such as a cellular phone, two-way pager, or personal digital assistant, the instant messaging system terminates its own session, determines the designated alternative pathway, and transfers the current instant message to the recipient's designated alternative communication device via the alternative pathway. As an example, the system of the present invention could establish a new (or alternative) instant messaging session, such as a two-way conversation between the sender and the recipient.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a block diagram of a computer workstation environment in which a messaging system of the present invention may be practiced;

FIG. 2 illustrates an exemplary networked computing environment in which the workstation and messaging system of FIG. 1 may be used;

FIG. 3 depicts a sample registry of alternative message delivery mechanisms that may be used with the messaging system of FIG. 1;

FIG. 4 is an example message flow for a message delivered according to the extended messaging system of FIG. 1;

FIG. 5 is a flow chart illustrating the operation of the messaging system of FIG. 1; and

FIG. 6 is comprised of FIGS. 6A and 6B, and represents a flow chart illustrating the certain forwarding rules that govern the operation (FIG. 5.) of the messaging system, according to a preferred embodiment of the present invention.

### DETAILED DESCRIPTION OF PREFERRED EMBODIMENTS

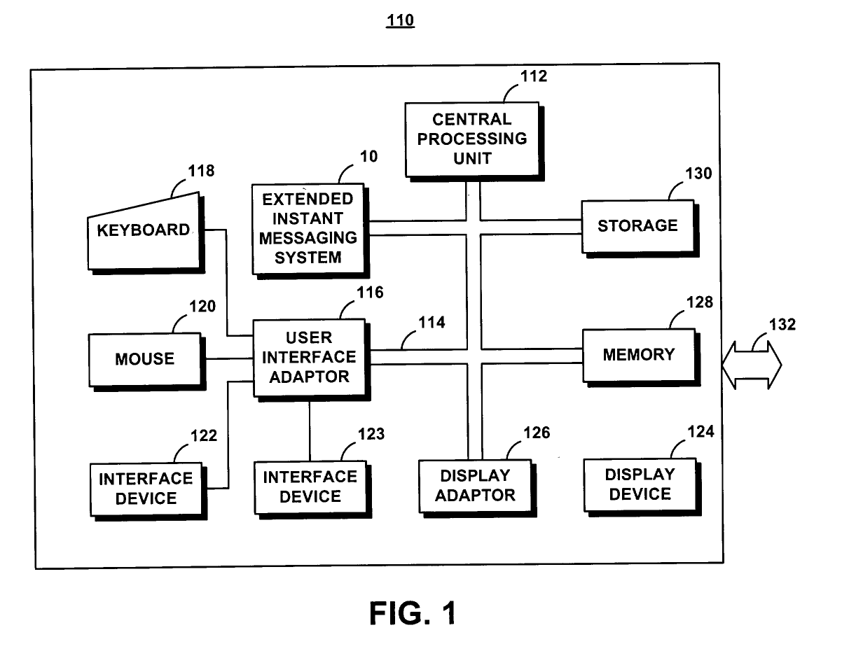

FIG. 1 illustrates a representative workstation 110 in which an instant messaging system 10 of the present invention may be practiced. System 10 includes a software or computer program product that is typically embedded within or installed on a host server 15. Alternatively, the system 10 can be saved on a suitable computer usable medium such as a diskette, a CD, a hard drive, or like storage devices.

The workstation 110 can be, for example, a personal computer (PC) that is connection to a plurality of peripheral devices. Typically, the workstation 110 includes a central processing unit (CPU) 112 and a bus 114 employed to connect and to enable communication between the central processing unit 112 and the other components of the workstation 110.

The workstation 110 further includes a user interface adaptor 116 that connects the central processing unit 112 via the bus 114 to one or more interface devices, such as a keyboard 118, a mouse 120, and/or other interface devices 122, 123, such as a touch screen, a digitized pad, and so forth. The bus 114 also connects a display device 124, such as a monitor or a liquid crystal display (LCD) screen, to the central processing unit 112 via a display adaptor 126. The bus 114 also connects the central processing unit 112 to a memory 128 and a storage device 130 such as a hard drive, diskette drive, tape drive, etc.

The workstation 110 may communicate with other computers or networks of computers, for example via a communications channel or modem 132. Alternatively, the workstation 110 may communicate using a wireless interface, such as a cellular digital packet data (CDPD) card. The workstation 110 may be associated with such other computers in a Local Area Network (LAN) or a Wide Area Network (WAN). The workstation 110 can also be a client in a client/server arrangement with another computer.

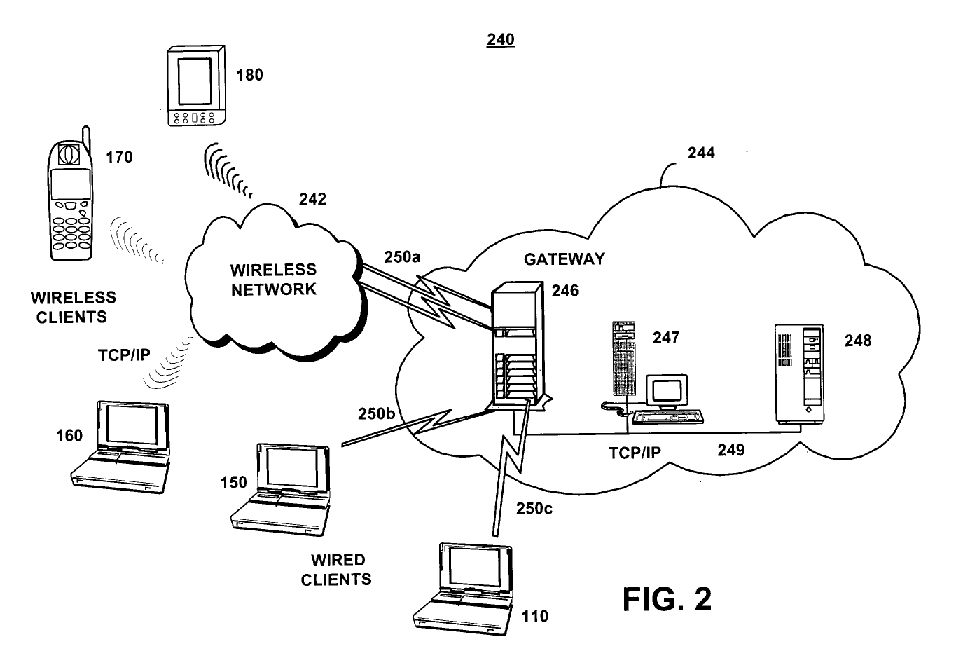

Referring now to FIG. 2, it illustrates a data processing network 240 in which the present messaging system 10 may be practiced. The network 240 includes, for example, a plurality of networks, such as a wireless network 242 and the Internet 244, each of which may connect a plurality of individual workstations, i.e., 110, 150, 160, 170, 180. Additionally, one or more Local Area Networks (LANs) may be included, where a Local Area Network may comprise a plurality of intelligent workstations coupled to a host processor.

The networks 242 and 244 may also include mainframe computers or servers, such as a gateway 246 or application server 247 that accesses a data repository 248. The gateway 246 serves as a point of entry into each network 244. The gateway 246 may be coupled to another network 242 by means of a communications link 250a. The gateway 246 may also be directly coupled to one or more workstations 110, 150, using communications links 250c, 250b, respectively. The gateway 246 may also be networked 249 to a storage device, such as data repository 248, using Transmission Control Protocol/Internet Protocol (TCP/IP) connection 249.

The gateway 246 may be located distally from the network 242, and similarly, the workstations 110, 150, 160,170, 180 may be located remotely from the networks 242 and 244. As an example, the network 242 may be located in California, while the gateway 246 may be located in Texas, and one or more of the workstations 110 may be located in New York. The workstation 110 may be connected to the wireless network 242 using a networking protocol, such as the TCP/IP or Apple Computer's AppleTalk, over a number of alternative connection media, such as cellular phone networks, radio frequency networks, satellite networks, etc.

The wireless network 242 is connected to the gateway 246 using a network connection 250a such as Transmission Control Protocol or User Datagram Protocol (UDP) over Internet Protocol, X.25, Frame Relay, Integrated Services Digital Network (ISDN), Public Switched Telephone Network (PSTN), and so forth. The workstation 110 may alternatively be connected directly to the gateway 246 using a dial up connection. Further, the networks 242 and 244 may be connect to one or more other networks (not shown), in an analogous manner to that depicted in FIG. 2.

The software programming code of the present invention may be embodied on any of a variety of known media for use with a data processing system, such as a diskette, hard drive, or CD-ROM. The code may be distributed on such media, or may be distributed to users from the memory or storage of one computer system over a network of some type to other computer systems for use by users of such other systems. Alternatively, the programming code may be embodied in the memory 128, and accessed by the central processing unit 112 using the bus 114. The techniques and methods for embodying software programming code in memory, on physical media, and/or distributing software code via networks are well known and will not be further discussed herein.

A sender's computer, i.e., 160, when using the present invention, may be connected to a server (or gateway 246) or to a workstation 110 embodying the instant messaging system 10 using a wired connection or a wireless connection. Wired connections are those that use physical media such as cables and telephone lines, whereas wireless connections use media such as satellite links, radio frequency waves, and infrared waves. Many connection techniques can be employed with these various media, such as: using the computer's modem to establish a connection over a telephone line; using a Local Area Network card such as Token Ring or Ethernet; using a cellular modem to establish a wireless connection, etc. The sender's computer 160 may be any type of computer processor, including laptop, handheld or mobile computers; vehicle-mounted devices; desktop computers; mainframe computers; etc., having processing and communication capabilities. The remote server 246, similarly, can be one of many computer types with processing and communication capabilities.

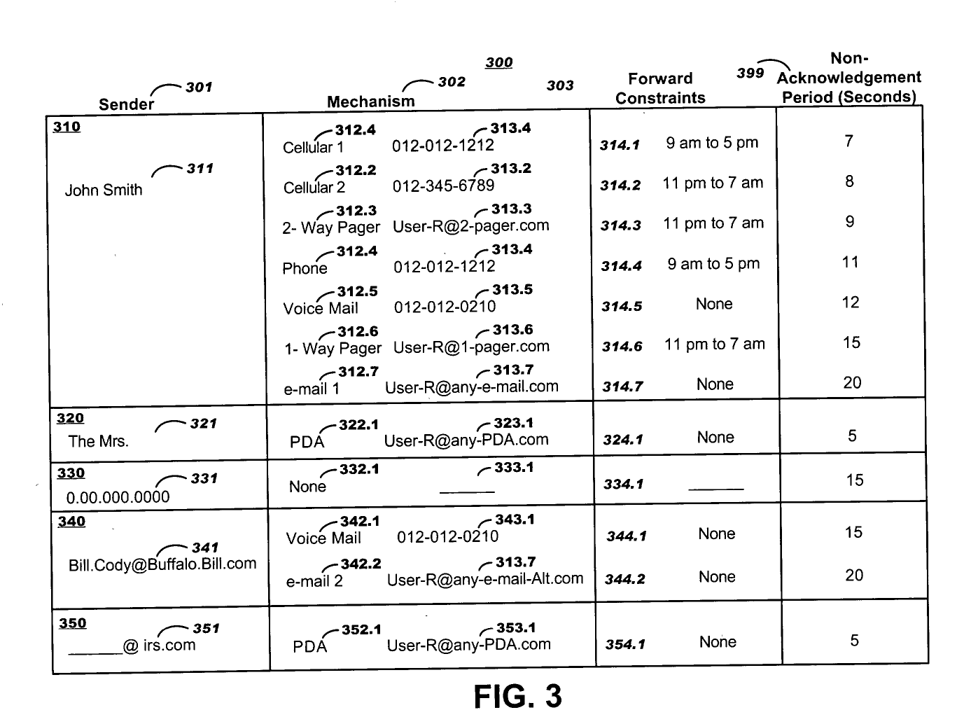

FIG. 3 illustrates alternative messaging mechanisms that have been registered in the workstation 110 according to an embodiment of the present invention. In this example, registry 300 contains entries 310, 320, 330, 340, 350 for four instant messaging system senders identified at 311, 321, 331, 341, 351.

The registered information is depicted in tabular form for purposes of illustration, although it should be clear that a number of alternative storage formats (such as entries in a directory or relational database) may be used without deviating from the inventive concepts disclosed herein. A number of available techniques for creating the registry may be used.

A sender's name 301 (or another suitable identifier, such as a unique user account number, Internet address or nickname) for each user is used to store and locate entries in the registry 300. Entries 311, 321, 331, 341, and 351, respectively, represent a name, a nickname, an account number, and an Internet-based address for five senders in the recipient's address book.

Entry 311, John Smith, is important to the recipient, as there are seven mechanisms in place to reach the recipient in the event that an instant message goes unacknowledged. As used herein, “instant message” includes a message that is sent using an instant messaging system and intended for real time delivery. By contrast, unacknowledged messages from sender 331, at account number: 0.00.000.0000, are not to be forwarded. Sender 320, representing “The Mrs.” is assigned a unique, private forwarding contact device, Personal Digital Assistant 322.1 at address location 323.1. Unacknowledged messages from sender 341, Bill.Cody@Buffalo.Bill.com, can only be forwarded to a 1-way or non-real time communications device such as voicemail or an e-mail address, which do not necessarily provide instant messaging.

A particular instant messaging system recipient may register more than one alternative messaging mechanism where he/she may be reached. The forwarding links for sender 311 are shown at entries 312.1 through 312.7 and 313.1 through 313.7 of a mechanism registration 302 entry. Entries 312.1 through 312.7 denote the different communications devices by which the recipient may be reached. It is important to know which device, the forwarding component of the instant messaging system 10 will attempt to connect with, because the system 10 may employ a transformation engine to synthesize a text message into a voice message in order to send it to a voicemail box as indicated in entry 312.5.

Entries 313.1 through 313.7 are the contact coordinates corresponding to entries 312.1 through 312.7. The hierarchical order of the entries for sender 311 is such that contact coordinates 313.1 are the highest while contact coordinates 313.7 are the lowest. In other words, contact coordinates 313.1 supercede those at 313.2, which in turn supercede those at 313.3 and so on.

Sender's 321 configuration specifies only one forwarding mechanism, a Personal Digital Assistant 322.1 and an address for it at entry 323.1. Sender 331 is blocked from message forwarding; hence the forwarding mechanism 332.1 is marked as “None” and the corresponding contact coordinates, 331.1 are left blank. The settings for sender 341 allow message transfer to a voicemail box 342.1 at contact 343.1 or to an alternate e-mail 342.2 at address 343.2. 371 In an optional aspect of the preferred embodiment, constraints may be used to limit the use of an alternative mechanism. For example, the recipient may not wish to receive messages from the sender 311 on his/her daytime cellular phone 1, entry 312.1, outside the business hours of 9 a.m. to 5 p.m., as denoted by entry 314.1. The recipient also restricts the use of his/her other cellular phone 2, entry 312.2, and 2-way pager, entry 312.3, to the hours between 11 p.m. and 7 a.m. The desk phone, entry 312.4, is subject to the same business hour constraints, entry 314.4, as is cellular 1. On the other hand, the voicemail box, entry 312.5, and e-mail 1, entry 312.7 have no constraints as denoted respectively by entries 314.5 and 314.7. The 1-way pager, entry 312.6, is limited in its use to the hours configured in entry 314.6, namely between 11 p.m. and 7 a.m.

The “None” entry 324.1 indicates that there are no constraints set on sender 321. So, unacknowledged messages from sender 321 may be forwarded to the Personal Digital Assistant at all times. There are no entries 334.1, because there is no forwarding mechanism for sender 331; that is to say that no constraints are needed in this case. For sender 341, Bill.Cody@Buffalo.Bill.com, the voicemail box, entry 342.1, and e-mail 2, entry 342.2 have no constraints.

Entry 399 is the time (in seconds) configurable by the user to determine when a received message is considered “unacknowledged”. That is if the recipient does not respond to the instant message within the time allotted in entry 399, the present invention triggers the corresponding forwarding mechanisms. In an alternative embodiment, the user may set different times for different senders. Another alternative embodiment may entitle the recipient to change or override the time value configured in entry 399.

Entry 351 is important to the recipient, as it allows the recipient to use simple rules for groups of senders. Entry 351 enables any sender within a certain identity range or address range to use a specific set of forwarding rules. In this example, any sender whose e-mail ID identifies them as calling from within a specific government agency will have their messages forwarded to the recipient's PDA if their message is unacknowledged within the specified time.

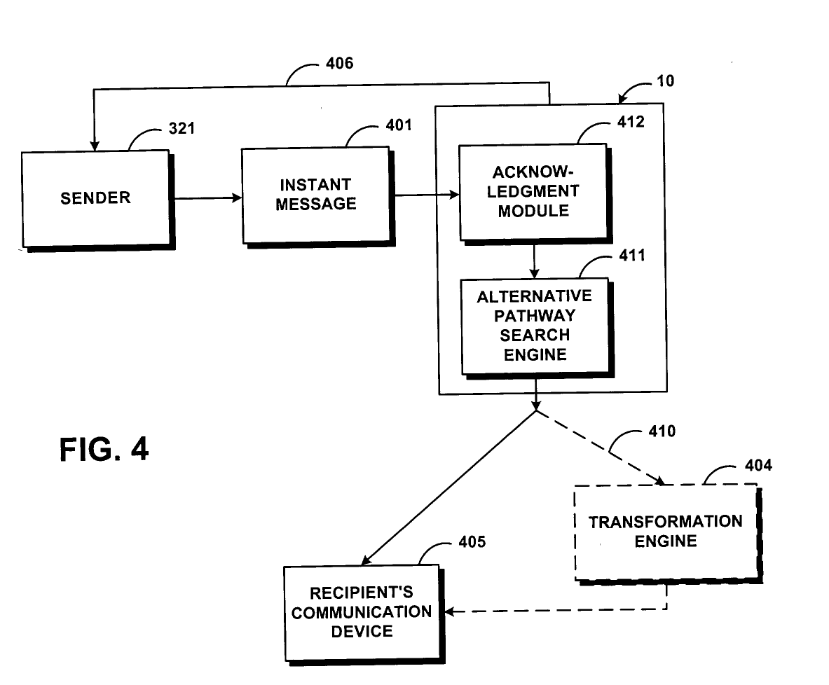

FIG. 4 shows a high-level example architecture of message flows implemented by the instant messaging system 10. These flows are also applicable for a non real time-based sender scenario, where the instant messaging system 10 may be replaced or complemented by a wireless messaging system. An instant message 401 is generated by a sender, such as “The Mrs.” 321 as illustrated in FIG. 3, and is sent to the system 10, destined to the recipient. For the purpose of illustration, the recipient is logged on to the instant messaging system 10 via the workstation 110, but is away from the workstation 110 at the time the message 401 reaches the workstation 110.

In a conventional design, the instant messaging system would deliver message 401 to an unattended terminal, giving the sender 321 a false indication that the message 401 was indeed delivered to, and received by the intended recipient. According to the present invention, however, the extended instant messaging system 10 receives the message 401, and determines whether the message 401 has or has not been acknowledged.

If the message 401 has been acknowledged, system 10 allows this message 401 to reside on the workstation 110. If however, system 10 determines that the message 401 has not been acknowledged by the recipient according to the forwarding rules, and causes an alternative pathway search engine 411 to search for alternative mechanisms or pathways to deliver the message 401 to the recipient.

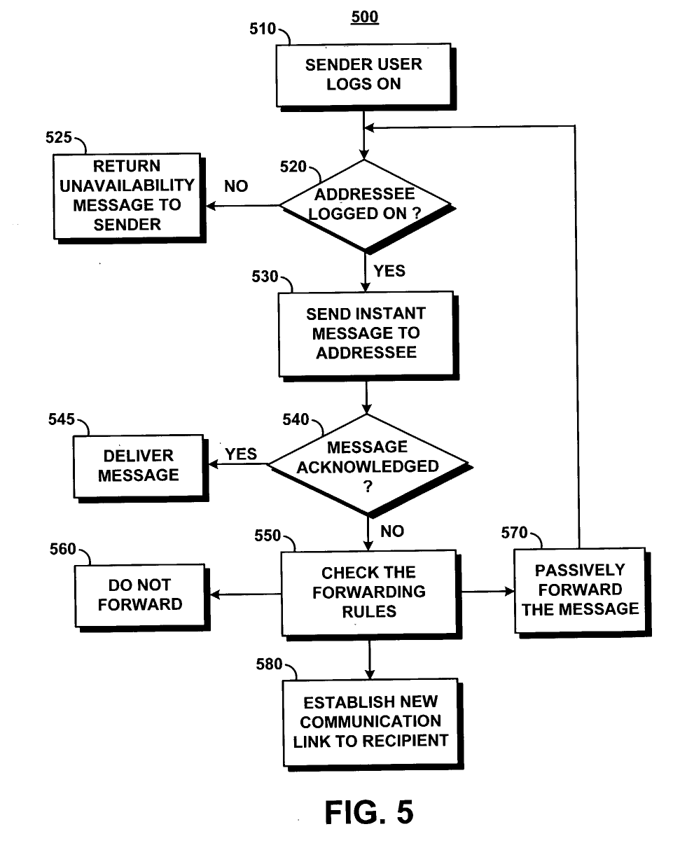

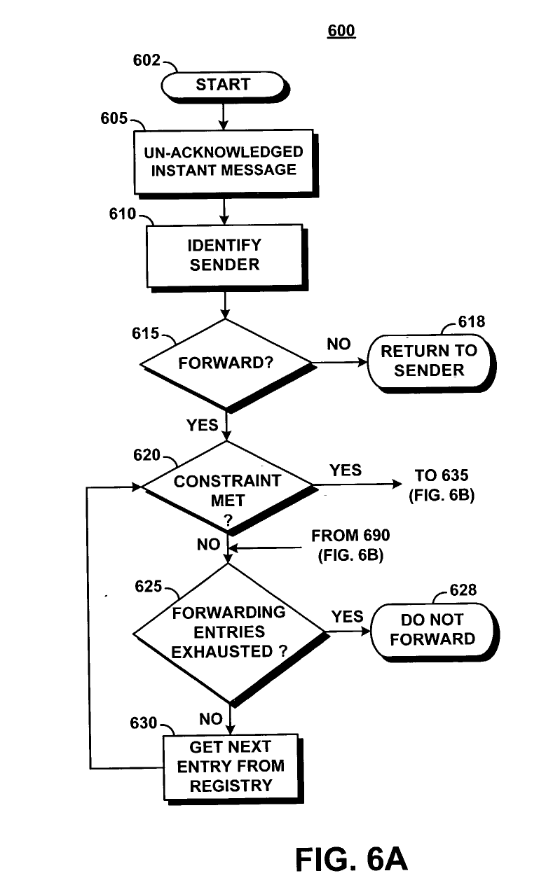

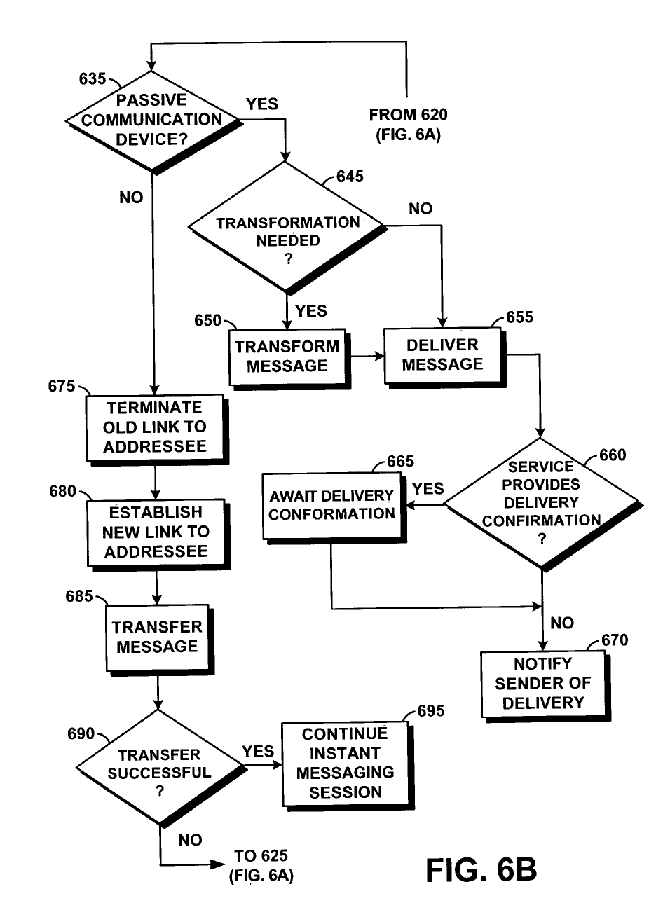

One preferred embodiment of a technique to search for alternative delivery mechanisms is discussed below in connection with FIGS. 5 and 6. Further, in the example above, assume that the extended instant messaging system 10 locates the sender's 321 forwarding entries in registry 300, enabling the sender 321 to reach the recipient by means of a personal data assistant 24 hours per day (entry 322.1). The system 10 forwards message 401 from sender 321 to the recipient's communication device 405 (in this case, personal digital assistant 322.1 in FIG. 3), using the registered address information 323.1.

The forwarded message 410 may optionally pass through a transformation engine 404 (shown in dashed lines), before being ultimately delivered to the recipient. This would be the case, for example, where a textual message 401 created by the sender is to be delivered through a non-textual mechanism such as a regular phone. The system 10 forwards the message 401 through a text-to-speech transformation process (such as a commercially-available voice synthesizer) using the transformation engine 404 prior to delivery to the destination device 405. When support for transformation engines of this type is provided in an implementation of the present invention, selection of the transformation engine to be used for a particular registered mechanism is performed by consulting a previously-stored look-up table (or other stored information, such as an association coded directly into the system 10) whereby the mechanism type is associated with the transformation engine to be used.

The message flow 406 indicates that the sender 321 is informed when an alternative message delivery mechanism, other than the intended original instant delivery method. Message flow 406 further notifies the sender of the type alternative mechanism to be used in relaying message 401 to the recipient.

FIG. 5 is a flow chart that illustrates a method (500) of operation of system 10 according to a preferred embodiment of the present invention. At block (or step) 510, a sender logs on to system 10, intending to send a real-time message 401 to an intended recipient or addressee. Method 500 then determines, at decision block 520, if the intended addressee is logged on to the instant messaging system 10. If not, method 500 returns a message to the sender advising of the unavailability of the intended recipient.

If at decision block 520 method 500 confirms that the intended recipient is logged on, system 10 requests the sender to send the message 401 at step 530. Method 500 then inquires at decision block 540, whether the message 401 has been acknowledged by the recipient (or the workstation 110). To this end, system 10 utilizes an acknowledgement module or mechanism 412 (FIG. 4) to confirm acknowledgement by the recipient. One such acknowledgment module 412 may be, for instance, Lotus Sametime®. If the message has been acknowledged within a predetermined period of time, method 500 delivers the message 401 to the workstation 110.

If, however, message 401 has not been acknowledged, method 500 proceeds to block 550 to examine the forwarding rules. At block 550, after a user-settable time (denoted by entry 399 in FIG. 3) has elapsed without the recipient acknowledging or responding to the instant message 401, system 10 identifies the message as “unacknowledged” and examines the forwarding rules to determine how to handle the unacknowledged message 401. An example of these rules can be seen in FIG. 3, where a table is user-configured to assess the forwarding profiles based on different senders.

At block 550, system 10 makes a decision as to which of three forwarding options 560, 570, 580 would be most appropriate to handle the message 401 from the particular sender 321. Though the present invention has been described herein at the granularity level of the sender 321, it should be clear that the forwarding rules could be set at the granularity level of the message 401, or at the combined granularity level of both the sender 321 and the message 401, so that the type and importance of the message 401 is taken into consideration when selecting the appropriate forwarding option (560, 570, 580) from the same (or different) sender 321.

If the first forwarding option 560 is selected, system 10 drops the message 401; that is it does not forward message 401 to the recipient, but may allow it to be stored on the workstation 110. This scenario is exemplified in the configuration for sender 331 in FIG. 3, where any message 401 from that sender 331 will not be forwarded to the recipient.

If the second forwarding option 570 has been selected, system 10 passively forwards the unacknowledged message 401 to one-way or non-real time communication device 405, such as voicemail, e-mail, or one-way pager, according to the forwarding rules illustrated in FIG. 3. For example, both forwarding mechanisms for sender 341, at entries 342.1 and 342.2, are passive; the first being a voicemail box and the second being an alternate e-mail address.

If the third forwarding option 580 has been selected, system 10 establishes a new communication channel, such as a two-link communication link. A first link is established between the recipient and workstation 110, and a second link is established between workstation 110 and the sender. Alternately, system 10 could disconnect the messaging link with the sender, and establishes a new direct communication channel between the sender and the recipient, that is the workstation 110 determines an optimal method to connect the sender and the recipient directly.

FIG. 6 illustrates a logical flow chart of a method 600 for implementing the forwarding rules according to a preferred embodiment of the present invention. Method 600 starts at block 602, and at block 605, the system 10 having determined that a message has not been acknowledged, that is the configured time at entry 399 in FIG. 3 is exceeded before an instant message is acknowledged, it triggers the alternative pathway search engine 411 (FIG. 4). As mentioned earlier, the forwarding rules include a number of user-settable parameters, such as time in seconds, at entry 399 of FIG. 3, that are used to classify a message as “unacknowledged.”

At block 610, method 600 identifies the sender by a unique user account number, Internet address, name or nickname as tabulated under entry 301 in FIG. 3. The entries for each sender are stored in the registry 300 of the recipient. If however, the sender is not identified by system 10, the unacknowledged message could be ignored, left on the workstation 110, or otherwise forwarded to the intended recipient according to a default forwarding rule. Alternatively, an appropriate notification message could be returned to the sender.

At decision block 615, method 600 checks the forwarding mechanism associated with the particular sender. If system 10 determines that the incoming message does not need to be forwarded, the message could be ignored, left on the workstation 110, or otherwise forwarded to the intended recipient according to a default forwarding rule; or alternatively, an appropriate notification message could be returned to the sender (block 618).

Otherwise, if system 10 determines that the incoming message should be forwarded, system 10 proceeds to decision block 620 and checks the forwarding rules for this particular sender and/or incoming message that are user-configured under entry 302 in FIG. 3. As an example, unacknowledged messages from sender 320, representing “The Mrs.” may be forwarded to the recipient's personal digital assistant 322.1 (FIG. 3) at address entry 323.1, User-R@any-PDA.com. However, unacknowledged messages from account number: 0.00.000.0000 (sender 331), are not forwarded as indicated by the “None” entry at 332.1.

At decision block 620, the system checks any constraints on the forwarding mechanism. If the relevant constraints are met, method 600 proceeds to decision block 635 (FIG. 6B); else, method 600 proceeds to decision block 625.

Each entry in the registry 300 in FIG. 3 may comprise a constraint associated with the alternative message delivery mechanism, that specifies a condition for use of an associated forwarding mechanism. The forwarding constraint comprises verifying whether the condition from the retrieved entry is met; and determining the availability of a particular forwarding mechanism once the forwarding constraint is met. The message may otherwise be rejected or disposed of appropriately when an associated forwarding mechanism is not available.

At decision block 625, method 600 checks if all the forwarding entries for a particular sender have been exhausted. If so, system 10 does not forward the incoming instant message (block 628). If, however, one or more entries still remain, system 10 proceeds to block 630. At block 630, system 10 indexes the next hierarchical entry in the sender profile in the registry 300 of FIG. 3, and returns to decision step 620.

The following example illustrates blocks or steps 620, 625, and 630 that iteratively evaluate the entries of the forwarding rules: An unacknowledged message from sender user 311 (FIG. 3) arrives at 11:07 p.m. The hierarchy of the forwarding mechanisms shows that the first alternate mechanism to which messages should be forwarded is 312.1, Cellular 1, but its availability is between 9:00 a.m. and 5:00 p.m. pursuant to constraint 314.1. As a result, system 10 discards Cellular 1 as a viable alternative, and checks the next hierarchical forwarding entry, namely mechanism 312.2 or Cellular 2, which is available from 11:00 p.m. to 7 a.m., as specified at entry 314.2, and finds it meeting the time constraint.

When a matching constraint is found at block 620, method 600 proceeds to decision block 635, where system 10 determines whether the device available for forwarding is a passive device (receive only) such as a one-way pager or a voicemail box, or an active device (send and receive) such as a cellular telephone or a two-way pager. For example, entry 312.3 indicates a two-way pager as a forwarding device, while entry 312.6 indicates a one-way pager as a forwarding device. If system 10 determines the forwarding device to be a passive device, method 600 continues to decision block 645; else, it proceeds to block 675.

At decision block 645, method 600 checks the compatibility of the unacknowledged message with the alternate destination device. That is, method 600 determines if the unacknowledged message requires any transformation prior to forwarding. If so, method 600 continues to block 650; otherwise, method 600 proceeds to step 655, and then deliver the message to a recipient's designated destination at step 655.

At block 650, having determined that a transformation is needed, the unacknowledged message undergoes a transformation and becomes ready for delivery to the recipient's designated communication device. This would be the case, for example, where a textual message is to be delivered through a non-textual mechanism such as a voicemail box. System 10 would then forward the message through a commercially available text-to-speech transformation engine 404 (FIG. 4). System 10 then delivers the message to a recipient's designated destination at step 655.

At decision block 660, if the messaging service provides delivery confirmation, method 600 continues to block 665; otherwise, method 600 continues to block 670. At block 665, in light of provision for delivery confirmation, system 10 awaits confirmation before proceeding to notify the sender, at step 670, of the delivery confirmation.

At block 670, system 10 notifies the sender of the message delivery. An example of step is illustrated in FIG. 4, where message flow 406 indicates that the sender 321 is informed whenever an alternate message delivery mechanism, other than the original instant messaging system has been, or will be used to forward the instant message to the recipient. Further, the message flow (or confirmation message) 406 may contain information identifying the alternative mechanism used.

At block 675, forwarding the message to a two-way communication device starts by terminating the old link to the intended addressee or recipient. This step may be necessary to conserve resources such as processing time.

At block 680, system 10 establishes a new link to the intended recipient between the recipient's workstation 110 and the alternate communications device that is available based on the forwarding rules. At block 685, having established a new two-link channel between the recipient and the sender, as described earlier, system 10 transfers the last unacknowledged message to the alternate communication device. Alternatively, the recipient's workstation 110 may determine another way to connect the sender and the recipient and to establish a direct communication channel between the sender and the recipient.

At decision block 690, system 10 waits for a reply to forward to the original sender. If the transfer is not successful, that is the message is again unacknowledged, method 600 proceeds to decision block 625 to determine the next forwarding device in the hierarchy of transfer devices, until the list is exhausted. Otherwise, method 600 continues to block 695.

At block 695, having successfully transferred the instant messaging session, system 10 establishes a new session with the alternate messaging medium, continuing the instant messaging session between the sender and recipient.

It is to be understood that the specific embodiments of the present invention that are described herein are merely illustrative of certain applications of the principles of the present invention. Numerous modifications may be made without departing from the scope of the invention. For instance, the field of the invention may be extended to any electronic messaging system, such as a chat server, over a wired or wireless network.

What is claimed is:

1. A method for enabling an instant messaging system to use an alternative message delivery path to deliver an instant message to a recipient, comprising:
determining if the recipient is logged on;
if the recipient is logged on, delivering the instant message to the recipient;
determining if the instant message has been acknowledged by the recipient; and
if the instant message has not been acknowledged, forwarding the instant message to the recipient using the alternative message delivery path.

2. The method of claim 1, wherein determining if the instant message has been acknowledged by the recipient comprises using a predetermined set of forwarding rules.

3. The method of claim 2, wherein determining if the instant message has been acknowledged by the recipient further comprises determining if the instant message is authorized for transfer to the recipient using the alternative message delivery path.

4. The method of claim 2, further comprising identifying the alternative message delivery path by which the instant message is to be forwarded.

5. The method of claim 4, wherein forwarding the instant message to the recipient using the alternative message delivery path comprises transmitting the instant message to one or more approved alternative communication devices.

6. The method of claim 5, wherein transmitting the instant message comprises using a wireless messaging service.

7. The method of claim 5, wherein the one or more approved alternative communication devices comprises one or more of: a cellular telephone, a pager, a personal digital assistant.

8. The method of claim 5, wherein transmitting the instant message to one or more approved alternative communication devices comprises forwarding a voicemail message.

9. The method of claim 5, wherein transmitting the instant message to one or more approved alternative communication devices comprises forwarding an email message.

10. The method of claim 1, wherein if the instant message has not been acknowledged, establishing an alternative instant message session to forward the instant message to the recipient.

11. A method for enabling an instant messaging system to use an alternative message delivery path, comprising:
sending an instant message to a recipient;
determining if the recipient is logged on;
if the recipient is logged on, delivering the instant message to the recipient;
then determining if the instant message has been acknowledged by the recipient; and
if the instant message has not been acknowledged, forwarding an alternative message to the recipient using the alternative message delivery path.

12. The method of claim 11, wherein determining if the instant message has been acknowledged by the recipient comprises using a predetermined set of forwarding rules.

13. The method of claim 12, wherein determining if the instant message has been acknowledged by the recipient further comprises determining if the instant message is authorized for transfer to the recipient using the alternative message delivery path.

14. The method of claim 12, further comprising identifying the alternative message delivery path by which the instant message is to be forwarded.

15. The method of claim 14, wherein forwarding the alternative message to the recipient using the alternative message delivery path comprises transmitting the alternative message to one or more approved alternative communication devices.

16. The method of claim 15, wherein transmitting the alternative message comprises using a wireless messaging service.

17. The method of claim 15, wherein the one or more approved alternative communication devices comprises one or more of: a cellular telephone, a pager, a personal digital assistant.

18. The method of claim 15, wherein transmitting the alternative message to one or more approved alternative communication devices comprises forwarding a voicemail message.

19. The method of claim 15, wherein transmitting the alternative message to one or more approved alternative communication devices comprises forwarding an email message.

20. The method of claim 11, wherein if the instant message has been acknowledged, the instant messaging system does not forward the alternative message.

21. A computer program product having instruction codes for enabling an instant messaging system to use an alternative message delivery path to deliver an instant message to a recipient, comprising:
a first set of instruction codes that determine if the recipient is logged on;
if the recipient is logged on, a second set of instruction codes deliver the instant message to the recipient;
a third set of instruction codes that determine if the instant message has been acknowledged by the recipient; and
if the instant message has not been acknowledged, a fourth set of instruction codes forward the instant message to the recipient using the alternative message delivery path.

22. The computer program product of claim 21, wherein the third set of instruction codes uses a predetermined set of forwarding rules to determine if the instant message has been acknowledged by the recipient.

23. The computer program product of claim 22, wherein the third set of instruction codes further determines if the instant message is authorized for transfer to the recipient using the alternative message delivery path.

24. The computer program product of claim 22, wherein the fourth set of instruction codes further identifies the alternative message delivery path by which the instant message is to be forwarded.

25. The computer program product of claim 24, wherein the fourth set of instruction codes transmits the instant message to one or more approved alternative communication devices.

26. The computer program product of claim 25, wherein the one or more approved alternative communication devices comprises a wireless messaging service.

27. The computer program product of claim 25, wherein the one or more approved alternative communication devices comprises one or more of: a cellular telephone, a pager, a personal digital assistant.

28. The computer program product of claim 25, wherein the fourth set of instruction codes transmits the instant message as a voicemail message.

29. The computer program product of claim 25, wherein the fourth set of instruction codes transmits the instant message as an email message.

30. The computer program product of claim 21, wherein, if the instant message has not been acknowledged, the fourth set of instruction codes establishes an alternative instant message session to forward the instant message to the recipient.

31. A system that enables an instant messaging system to use an alternative message delivery path to deliver an instant message to a recipient, comprising:
means for determining if the recipient is logged on;
means for delivering the instant message to the recipient if the recipient is logged on;
means for determining if the instant message has been acknowledged by the recipient; and
means for forwarding the instant message to the recipient using the alternative message delivery path, if the instant message has not been acknowledged.

32. The system of claim 31, wherein the means for determining if the instant message has been acknowledged uses a predetermined set of forwarding rules.

33. The system of claim 32, wherein the means for determining if the instant message has been acknowledged, further determines if the instant message is authorized for transfer to the recipient using the alternative message delivery path.

34. The system of claim 32, wherein the means for forwarding the instant message to the recipient further identifies the alternative message delivery path by which the instant message is to be forwarded.

35. The system of claim 34, wherein the means for forwarding the instant message to the recipient transmits the instant message to one or more approved alternative communication devices.

36. The system of claim 35, wherein the one or more approved alternative communication devices comprises a wireless messaging service.

37. The system of claim 35, wherein the one or more approved alternative communication devices comprises one or more of: a cellular telephone, a pager, a personal digital assistant.

38. The system of claim 35, wherein the means for forwarding the instant message to the recipient transmits the instant message as a voicemail message.

39. The system of claim 35, wherein the means for forwarding the instant message to the recipient transmits the instant message as an email message.

40. The system of claim 31, wherein, if the instant message has not been acknowledged, the means for forwarding the instant message to the recipient establishes an alternative instant message session to forward the instant message to the recipient.
